(19) United States
(12) Patent Application Publication
(10) Pub. No.: US 2025/0317543 A1
(43) Pub. Date: Oct. 9, 2025

(54) INCOHERENT HYBRID IMAGING SYSTEMS

(71) Applicant: University of Tartu, Tartu (EE)

(72) Inventors: VIJAYAKUMAR ANAND, Tartu (EE); SHIVASUBRAMANIAN GOPINATH, Tartu (EE); ARAVIND SIMON JOHN FRANCIS RAJESWARY, Tartu (EE)

(21) Appl. No.: 19/098,373

(22) Filed: Apr. 2, 2025

Related U.S. Application Data
(60) Provisional application No. 63/574,523, filed on Apr. 4, 2024.

(51) Int. Cl. H04N 13/167; G02B 5/00; G06F 3/04847; H04N 13/239

(52) U.S. Cl. CPC H04N 13/167; G06F 3/04847; H04N 13/239; G02B 5/001

(57) ABSTRACT

An incoherent hybrid imaging system for changing axial resolving power (ARP) without affecting lateral resolving power (LRP) after recording a picture, video, and/or a hologram is disclosed.

### CROSS REFERENCE TO RELATED APPLICATION

This applications claims the benefit of U.S. Provisional Patent Application Ser. No. 63/574,523, entitled “INCOHERENT HYBRID IMAGING SYSTEMS,” FILED Apr. 4, 2024, which is incorporated herein by reference.

### BACKGROUND OF THE INVENTION

### 1. Field of the Invention

The present invention relates to imaging systems.

### 2. Description of the Related Art

The lateral resolving power (LRP) and axial resolving power (ARP) are two of the most important characteristics of an imaging system given as ˜λ/NA and ˜λ/NA² respectively, where NA is the numerical aperture given as ˜D/2f, where D is the diameter of the lens and f is the focal length. In all imaging systems, LRP and ARP are interdependent, and changing one by changing the NA affects the other. D. B. Murphy, Fundamentals of Light Microscopy and Electronic Imaging, John Wiley & Sons (Wiley-Liss, 2001). In many scenarios, it is desirable to change one property without changing the other. For instance, in microscopy, when studying thick and sparse objects, it is desirable to decrease the ARP without affecting the LRP so that the entire measurement can be completed within one or a few recordings. In the direct imaging approach, an axicon with a long focal depth is often used to image objects with a low axial resolution. However, the Bessel beam generated by an axicon has sidelobes which suppress some of the high spatial frequencies during imaging. S. N. Khonina, N. L. Kazanskiy, S. V. Karpeev, and M. A. Butt, “Bessel beam: Significance and applications—A progressive review,” Micromachines 11, 997 (2020); Z. Zhai, X. He, X. Yu, D. Liu, Q. Lv, Z. Xiong, X. Wang, Z. Xu, “Parallel Bessel beam arrays generated by envelope phase holograms,” Opt. Laser Eng., 161, 107348 (2023); V. Anand, J. Rosen and S. Juodkazis, “Review of engineering techniques in chaotic coded aperture imagers,” Light: Advanced Manufacturing, 3, 1-13 (2022); G. Indebetouw, “Nondiffracting optical fields: some remarks on their analysis and synthesis,” J. Opt. Soc. Am. A 6, 150-152 (1989). Either engineering approaches are needed to suppress the sidelobes or deconvolution methods are needed to process the blurred images generated by Bessel beams. R. Dharmavarapu, S. Bhattacharya, and S. Juodkazis, “Diffractive optics for axial intensity shaping of Bessel beams,” J. Opt. 20(8), 085606 (2018); D. Smith, S. H. Ng, M. Han, T. Katkus, V. Anand, K. Glazebrook and S. Juodkazis, “Imaging with diffractive axicons rapidly milled on sapphire by femtosecond laser ablation,” Appl. Phys. B. 127, 154 (2021). Alternatives to Bessel beams to image objects with a high focal depth are available for direct imaging which includes axilens and holographic beam shaping elements. N. Davidson, A. A. Friesem, and E. Hasman, “Holographic axilens: high resolution and long focal depth,” Opt. Lett. 16, 523-525 (1991); S. Gorelick, D. M. Paganin, A. De Marco, “Axilenses: Refractive micro-optical elements with arbitrary exponential profiles,” APL Photonics, 5, 106110 (2020); J. Rosen and A. Yariv, “Snake beam: a paraxial arbitrary focal line,” Opt. Lett. 20, 2042-2044 (1995); T. Latychevskaia and H.-W. Fink, “Inverted Gabor holography principle for tailoring arbitrary shaped three-dimensional beams,” Sci. Rep. 6, 26312 (2016). However, even in the above cases, post-processing techniques are necessary to obtain a high-quality image. In indirect imaging methods such as holography, the different planes of an object are observed digitally using computational refocusing in the form of numerical back propagation instead of manual refocusing as it is done in direct imaging methods. J. Rosen, A. Vijayakumar, M. Kumar, M. R. Rai, R. Kelner, Y. Kashter, A. Bulbul, and S. Mukherjee, “Recent advances in self-interference incoherent digital holography,” Adv. Opt. Photon. 11, 1-66 (2019); J. P. Liu, T. Tahara, Y. Hayasaki, and T. C. Poon, “Incoherent digital holography: a review,” Appl. Sci. 8, 143 (2018); T. Tahara, Y. Zhang, J. Rosen, A. Vijayakumar, L. Cao, J. Wu, T. Koujin, A. Matsuda, A. Ishii, Y. Kozawa, R. Okamoto, R. Oi, T. Nobukawa, K. Choi, M. Imbe, and T.-C. Poon, “Roadmap of incoherent digital holography,” Appl. Phys. B 128, 193 (2022). Like direct imaging methods, holography methods also have the same relationship between LRP and ARP which makes tuning one property independent of another impossible.

Hybridization is a powerful technique used for creating mixed characteristics that are not naturally available and it means different things in different fields. In holography, the hybridization approach uses a combination of different types of optical fields on a special basis to create mixed imaging characteristics. Fresnel incoherent correlation holography (FINCH) is a widely used incoherent digital holography (IDH) technique. J. Rosen and G. Brooker, “Digital spatially incoherent Fresnel holography,” Opt. Lett. 32, 912-914 (2007); G. Brooker, N. Siegel, V. Wang, and J. Rosen, “Optimal resolution in Fresnel incoherent correlation holographic fluorescence microscopy,” Opt. Express 19, 5047-5062 (2011). In FINCH, light from an object point is split into two, differently modulated by two quadratic phase masks and interfered to create a self-interference hologram. The image of the object is then reconstructed by numerical back propagation of the hologram. FINCH, in inline configuration, requires at least three camera shots with different phase shifts followed by a computational superposition to reconstruct object information without twin image and bias terms. FINCH has a higher LRP but a lower ARP than those of direct incoherent imaging systems with the same NA. In FINCH, a hybridization method was applied by changing one of the two beam modulations from a quadratic phase to a spiral phase to achieve edge enhancement in reconstructed images. P. Bouchal and Z. Bouchal, “Selective edge enhancement in three-dimensional vortex imaging with incoherent light,” Opt. Lett. 37, 2949-2951 (2012). Another incoherent digital holography (IDH) technique called coded aperture correlation holography (COACH), was developed in 2016 which has the same LRP and ARP as those of direct incoherent imaging systems. A. Vijayakumar, Y. Kashter, R. Kelner, and J. Rosen, “Coded aperture correlation holography—a new type of incoherent digital holograms,” Opt. Express 24, 12430-12441 (2016). A hybridization method was developed by combining FINCH and COACH such that the LRP and ARP can be tuned between the limits of FINCH and COACH. A. Vijayakumar, Y. Kashter, R. Kelner, and J. Rosen, “Coded aperture correlation holography (COACH) system with improved performance [Invited],” Appl. Opt. 56, F67-F77 (2017). This allows for the creation of on-demand 3D imaging characteristics tailored for different studies. In the case of the FINCH-COACH system, the change in ARP resulted in a change in LRP but the ARP-LRP pairs of the hybrid FINCH-COACH systems cannot be obtained naturally from either FINCH or COACH.

The development of COACH connected two sub-fields of imaging namely incoherent digital holography (IDH) and coded aperture imaging (CAI) as the hologram recording in COACH is similar to that in incoherent digital holography (IDH) but the reconstruction is similar to that in coded aperture imaging (CAI). J. G. Ables, “Fourier transform photography: a new method for X-ray astronomy,” Publ. Astron. Soc. Aust. 1, 172-173 (1968); R. H. Dicke, “Scatter-hole cameras for X-rays and gamma rays,” Astrophys. J. 153, L101-L106 (1968); E. E. Fenimore and T. M. Cannon, “Coded aperture imaging with uniformly redundant arrays,” Appl. Opt. 17, 337-347 (1978); W. Chi and N. George, “Optical imaging with phase-coded aperture,” Opt. Express 19, 4294-4300 (2011); R. Horisaki, Y. Ogura, M. Aino, and J. Tanida, “Single-shot phase imaging with a coded aperture,” Opt. Lett. 39, 6466-6469 (2014). Subsequently, interferenceless COACH (I-COACH) was developed which has the advantages of both incoherent digital holography (IDH) and coded aperture imaging (CAI). A. Vijayakumar and J. Rosen, “Interferenceless coded aperture correlation holography—a new technique for recording incoherent digital holograms without two-wave interference,” Opt. Express 25, 13883-13896 (2017). In I-COACH, the complete 3D information of an object was recorded without two-beam interference for the first time. The first version of I-COACH used a quasi-random phase mask and matched filter for image reconstruction and required at least three camera shots as FINCH and COACH. J. L. Horner and P. D. Gianino, “Phase-only matched filtering,” Appl. Opt. 23 (6), 812-816 (1984). Later, a new reconstruction method called non-linear reconstruction (NLR) was developed that enabled single-shot capability in I-COACH. M. R. Rai, A. Vijayakumar, and J. Rosen, “Non-linear adaptive three-dimensional imaging with interferenceless coded aperture correlation holography (I-COACH),” Opt. Express 26, 18143-18154 (2018). With NLR, I-COACH was implemented with different deterministic optical fields such as Bessel, Laguerre-Gaussian, and higher-order Bessel beams, but the reconstruction was noisy. D. Smith, et. al. “Nonlinear reconstruction of images from patterns generated by deterministic or random optical masks—concepts and review of research,” J. Imaging 8, 174 (2022). Recently, a novel computational reconstruction method called the Lucy-Richardson-Rosen algorithm (LR²A) was developed by combining NLR and the widely used Lucy-Richardson algorithm (LRA) and implemented for 3D imaging using mid-infrared optical fields with Cassegrain objective lenses as coded apertures. V. Anand, M. Han, J. Maksimovic, S. H. Ng, T. Katkus, A. Klein, K. Bambery, M. J. Tobin, J. Vongsvivut and S. Juodkazis, “Single-shot mid-infrared incoherent holography using Lucy-Richardson-Rosen algorithm,” Opto-Electron. Sci. 1, 210006 (2022); W. H. Richardson, “Bayesian-based iterative method of image restoration,” J. Opt. Soc. Am. 62, 55-59 (1972); L. B. Lucy, “An iterative technique for the rectification of observed distributions,” Astron. J. 79, 745-754 (1974). The LR²A method was found to perform better than NLR and LRA for deterministic optical fields with a symmetric intensity distribution. P. A. Praveen, et. al. “Deep deconvolution of object information modulated by a refractive lens using Lucy-Richardson-Rosen algorithm,” Photonics, 9, 625 (2022); S. Gopinath, et. al. “Implementation of a large-area diffractive lens using multiple sub-aperture diffractive lenses and computational reconstruction,” Photonics 10, 3 (2023); A. Jayavel, et. al. “Improved classification of blurred images with deep-learning networks using Lucy-Richardson-Rosen algorithm,” Photonics 10, 396 (2023). As is known, deterministic optical fields have many interesting propagation characteristics that can be exploited for imaging applications.

The capability to tune ARP independent of LRP has been demonstrated in I-COACH using a sparse array of Bessel beams, Airy beams, and self-rotating beams. V. Anand, “Tuning axial resolution independent of lateral resolution in a computational imaging system using Bessel speckles,” Micromachines 13, 1347 (2022); R. Kumar, V. Anand and J. Rosen, “3D single shot lensless incoherent optical imaging using coded phase aperture system with point response of scattered airy beams,” Sci. Rep. 13, 2996 (2023); A. Bleahu, et. al. “3D incoherent imaging using an ensemble of sparse self-rotating beams,” Opt. Express 31, 26120-26134 (2023). In the above studies, the ARP was tuned by controlling the randomness which resulted in noisy reconstructions. Deconvolution methods have been developed to digitally refocus information, however such methods are not suitable as, when one plane at a particular depth is refocused, other planes at different depths are blurred. P. A. Praveen, et. al. “Deep deconvolution of object information modulated by a refractive lens using Lucy-Richardson-Rosen algorithm,” Photonics, 9, 625 (2022). While there are techniques such as the above that allow one to change ARP independent of LRP, it is impossible to change ARP after completing the recording of a picture, video, or a hologram. There are certain previously developed methods (Rai and Rosen; M. R. Rai and J. Rosen, “Depth-of-field engineering in coded aperture imaging,” Opt. Express 29, 1634-1648 (2021),” and Applicant's own group; V. Anand, “Tuning axial resolution independent of lateral resolution in a computational imaging system using Bessel speckles,” Micromachines 13, 1347 (2022); R. Kumar, V. Anand and J. Rosen, “3D single shot lensless incoherent optical imaging using coded phase aperture system with point response of scattered airy beams,” Sci. Rep. 13, 2996 (2023); A. Bleahu, et. al. “3D incoherent imaging using an ensemble of sparse self-rotating beams,” Opt. Express 31, 26120-26134 (2023)) that were originally developed for real-time tuning of ARP and for separating objects with the same lateral locations, and can be efficiently adapted for tuning ARP after completing the recording process. However, the above techniques cannot be applied to existing imaging systems such as digital cameras, mobile phone cameras, cinematography systems, and microscopes that predominantly use refractive optics.

### SUMMARY OF THE INVENTION

It is, therefore, an object of the present invention to provide an incoherent hybrid imaging system for changing axial resolving power (ARP) without affecting lateral resolving power (LRP) after recording a picture, video, and/or a hologram. The system comprises a point object located at (r̅ₛ, zₛ) and emitting light with an amplitude of Is, at least one image sensing device, processing systems allowing for changes to axial resolving power without affecting LRP after recording a picture, video, and/or a hologram, and a graphical user interface allowing for adjustment of the axial resolving power.

Other objects and advantages of the present invention will become apparent from the following detailed description when viewed in conjunction with the accompanying drawings, which set forth certain embodiments of the invention.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a schematic of the INCoherent Hybrid Imaging Systems (INCHIS)-H1 embodiment. FIG. 1 shows the optical configuration of INCHIS-H1. zₛ, zₕ, are object and image distances, D is the diameter of the aperture, TAP-GSA is transport of amplitude into phase based on Gerchberg-Saxton algorithm, l_{PSF} is the point spread intensity distribution, [symbol] is phase-only filtered version of l_{PSF}, Δz=0 is the plane of interest, DoF is degrees of freedom and T1 and T2 are strengths of the phase modulators namely lens and an axicon respectively. The axial distributions were generated using a phase-only filter.

FIG. 2 is a schematic of the INCHIS-H2 embodiment. FIG. 2 shows the optical configuration of INCHIS-H2. zₛ, zₕ are object and image distances, D is the diameter of the aperture, l_{PSF} is the point spread intensity distribution, [symbol] is phase-only filtered version of l_{PSF}, Δz=0 is the plane of interest, T₁ and T₂ are strengths of the intensity distributions of lens and an axicon respectively. The axial distributions were generated using a phase-only filter.

FIG. 3 is a schematic of LR²A. ML-maximum likelihood; OTF—optical transfer function; p-number of iterations; \textcircled{X}-2D convolutional operator; [symbol] —Fourier transform, [symbol] *—complex conjugate operation following a Fourier transform, [symbol] ⁻¹—inverse Fourier transform, Rₚ and R^{(p+1)} are the p^{th} and (p+l)^{th} solutions, lₒ was used as the initial guess solution R^{p=1}, ˜Fourier transform of a variable.

FIGS. 4(a) and 4(b) respectively show the CIPHR logo and the logo of University of Tartu used as test objects O1 and O2 located at zₛ=30 cm and zₛ=27 cm respectively.

FIG. 5 shows the magnitude and phase of the diffractive element for different compositions of lens and axicon for INCHIS-H1, in particular, magnitude and phase of the diffractive element for (T₁=1, T₂=0), (T₁=0.75, T₂=0.25), (T₁=0.5, T₂=0.5), (T₁=0.25, T₂=0.75) and (T₁=0, T₂=1) for INCHIS-H1.

FIG. 6, which comprises 6(a1), 6(a2), and 6(b)-6(z), shows various results for INCHIS-H1. INCHIS-H1: (a1) Axial intensity distributions for (T₁=1, T₂=0), (T₁=0.75, T₂=0.25), (T₁=0.5, T₂=0.5), (T₁=0.25, T₂=0.75) and (T₁=0, T₂=1). (a2) Plot of normalized area under the curve for different values of T₁ and T₂. The simulated images of the l_{PSF}(zₛ=30 cm), l_{PSF}(zₛ=27 cm), l_{O} and their reconstructions at the two planes l_{R}(zₛ=30 cm) and l_{R}(zₛ=27 cm) using LR²A are shown in 6(b)-6(z). The depth of focus is gradually increased and ARP is gradually decreased as the element is changed from lens to axicon through hybrid states.

FIG. 7, which comprises 7(a1), 7(a2), and 7(b)-7(z), shows various results for INCHIS-H2. INCHIS-H2: (a1) Axial intensity distributions for (T₁=1, T₂=0, (T₁=0.75, T₂=0.25), (T₁=0.5, T₂=0.5), (T₁=0.25, T₂=0.75) and (T₁=0, T₂=1). (a2) Plot of normalized area under the curve for different values of T₁ and T₂. The simulated images of the l_{PSF}(zₛ=30 cm), l_{PSF}(zₛ=27 cm), l_{O} and their reconstructions at the two planes l_{R}(zₛ=30 cm) and l_{R}(zₛ=27 cm) using LR²A are shown in 7(b)-7(z). The depth of focus is gradually increased and ARP is gradually decreased as the element is changed from lens to axicon through hybrid states.

FIG. 8 is a photograph of an experimental setup in accordance with an embodiment. (1) LED, (2) iris, (3) refractive lens L1 (f=50 mm), (4) object/pinhole, (5) iris, (6) refractive lens L2 (f=50 mm), (7) polarizer (8) beam splitter, (9) SLM, (10) image sensor. (The red line shows the path of the beam from LED to image sensor).

FIG. 9, which comprises 9(a1)-9(a5), 9(b1)-9(b5), 9(c1)-9(c5), 9(d1)-9(d5), 9(e1)-9(e5), 9(f1)-9(f5), and 9(g), shows various phase masks, l_{PSF} and results for INCHIS-H1. Phase masks, l_{PSF}(zₛ=5 cm), l_{PSF}(zₛ=5.6 cm), l_{O}, reconstruction results l_{R}(zₛ=5 cm) and l_{R}(zₛ=5.6 cm) for: (T₁=0, T₂=1), (T₁=0.25, T₂=0.75), (T₁=0.5, T₂=0.5), (T₁=0.75, T₂=0.25), and (T₁=1, T₂=0) are shown from FIGS. (a1) to (a5), (b1) to (b5), (c1) to (c5), (d1) to (d5), (e1) to (e5), and (f1) to (f5), respectively. (g) Direct image when both objects are in the same plane.

FIG. 10 shows the plot of normalized ratio S for different compositions of lens and axicon for INCHIS-H1. Normalized ratio S for (T₁=1, T₂=0), (T₁=0.75, T₂=0.25), (T₁=0.5, T₂=0.5), (T₁=0.25, T₂=0.75), and (T₁=0, T₂=1).

FIG. 11, which comprises 11(a1)-11(a5), 11(b1)-11(b5), 11(c1)-11(c5), 11(d1)-11(d5), and 11(e1)-1(e5), shows various phase masks, l_{PSF} and results for INCHIS-H2. l_{PSF}(zₛ=5 cm), l_{PSF}(zₛ=5.6 cm), l_{O}, reconstruction results l_{R}(zₛ=5 cm) and l_{R}(zₛ=5.6 cm) for: (T₁=0, T₂=1), (T₁=0.25, T₂=0.75), (T₁=0.5, T₂=0.5), (T₁=0.75, T₂=0.25), and (T₁=1, T₂=0) are shown from FIGS. (a1) to (a5), (b1) to (b5), (c1) to (c5), (d1) to (d5) and (e1) to (e5), respectively.

FIG. 12 shows the plot of normalized ratio S for different compositions of lens and axicon for INCHIS-H2. Normalized ratio S for (T₁=1, T₂=0), (T₁=0.75, T₂=0.25), (T₁=0.5, T₂=0.5), (T₁=0.25, T₂=0.75), and (T₁=0, T₂=1).

FIG. 13 is a photograph of the experimental set up of INCHIS-H2 with refractive elements.

FIG. 14, which comprises 14(a1)-9(a6), 14(b1)-14(b6), 14(c1)-14(c6), 14(d1)-14(d6), 14(e1)-14(e6), shows various results for INCHIS-H2. The l_{PSF}(zₛ=10 cm), l_{PSF}(zₛ=11.7 cm), l_{O}, reconstuction results l_{R}(zₛ=10 cm) and l_{R}(zₛ=11.7 cm) for: (T₁=0, T₂=1), (T₁=0.25, T₂=0.75), (T₁=0.5, T₂=0.5), (T₁=0.75, T₂=0.25), (T₁=0.875, T₂=0.125) and (T₁=1, T₂=0) are shown from FIGS. (a1) to (a6), (b1) to (b6), (c1) to (c6), (d1) to (d6) and (e1) to (e6) respectively.

FIG. 15 shows axial intensity distributions for binary phase element for different compositions of lens and axicon. Axial intensity distributions for (T₁=1, T₂=0), (T₁=0.75, T₂=0.25), (T₁=0.5, T₂=0.5), (T₁=0.25, T₂=0.75) and (T₁=0, T₂=1) for a binary phase element. The anomalous axial regions are indicated by a red dotted circle with yellow glow.

FIG. 16 is a model of graphical user interface for use with the systems.

### DESCRIPTION OF THE PREFERRED EMBODIMENTS

The detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as a basis for teaching one skilled in the art how to make and/or use the invention.

As discussed above, axial resolving power (ARP) is one of the cornerstones of imaging systems. In conventional imaging systems, changing ARP by changing the numerical aperture affects lateral resolving power (LRP). Prior to the present invention, it was impossible to change the ARP after completion of a recording process. The present invention allows one to change ARP without affecting LRP after recording a picture, video, and/or a hologram. While the term “image” is used throughout the present disclosure, the term “image” should be broadly construed to encompass images, videos, holograms, etc.

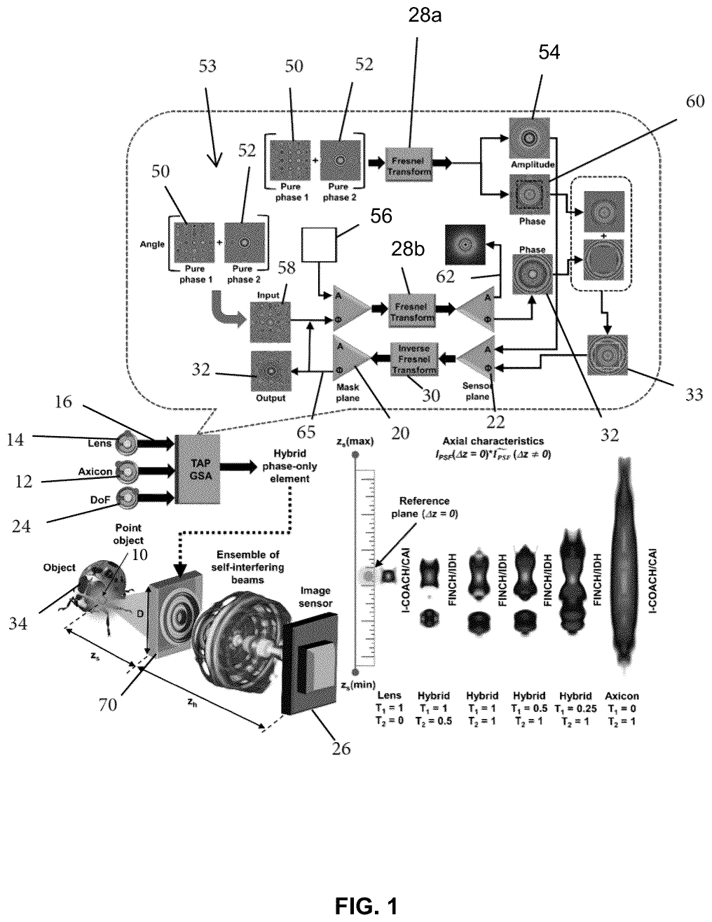

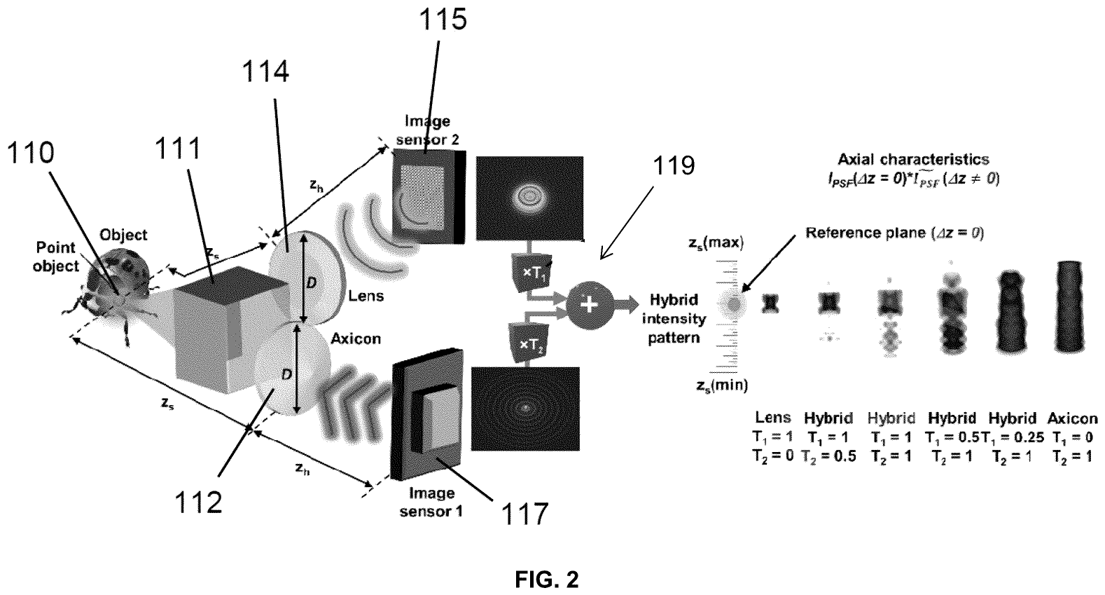

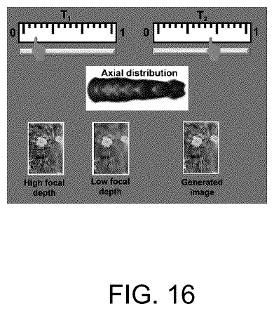

In a very general overview, and with reference to the schematics of embodiments disclosed in FIGS. 1 and 2, the system is considered to include at least one image sensing device and processing system allowing for changes to ARP without affecting LRP after recording a picture, video, and/or a hologram. In accordance with one embodiment, adjustment of the ARP in either embodiment may be controlled via a sliding scale, for example, as implemented via a graphical user interface. As will be appreciated based upon the following disclosure, the sliding scale is used to adjust T₁ and T₂ (that is, the strengths of the phase modulators, namely lens and axicon, respectively) of the INCoherent Hybrid Imaging Systems of the present invention for the purpose of adjusting the ARP in a desired manner. The graphical user interface allows a user to set the values of T₁ and T₂ and will show the corresponding axial distribution in 3D. The original images and the output. A model is shown in FIG. 16.

The first embodiment as disclosed with reference to FIG. 1, INCHIS-H1, requires pre-engineering of multifunctional phase masks 70 using the recently developed modified Gerchberg-Saxton algorithm and an active device, such as a spatial light modulator. In accordance with the first embodiment, INCHIS-H1, an IDH-like architecture is used to convert every object point into at least two beams, that is, a Bessel beam and a spherical beam. A self-interference is created between the Bessel beam and the spherical beam. The strengths of the beams are controlled to tune the ARP between the limits of the Bessel beam and spherical beam. ARP is tuned between the limits of coded aperture imaging (CAI) with the Bessel beam and coded aperture imaging (CAI) with the spherical beam. At all other points the INCHIS-H1 system is incoherent digital holography (IDH) with self-interfering Bessel and spherical beams. All possible ARPs are bounded by the coded aperture imaging (CAI) with only Bessel beam and only spherical beam and incoherent digital holography (IDH) with an ensemble of Bessel and spherical beams at all other points.

The system disclosed in FIG. 2, this is INCHIS-H2 or the second embodiment, includes two image sensing devices, for example, a first camera and a second camera. The first and second cameras have identical configurations especially the field of view. The recording set up therefore consists of two optical channels, one (for example, the first camera) with an imaging element such as an axicon that has a high focal depth and another (for example, the second camera) with a different imaging element with a low focal depth such as a lens. There is a camera for every optical channel. As such, the first camera records the scene with a high focal depth and the second camera records the scene with a low focal depth. Using the present invention, one may readily adjust the ARP without adversely affecting the LRP of a recorded image, video, hologram, etc.

In practice, two files based upon the image, video, or hologram are simultaneously created. The first file based upon the image, video, or hologram with a high focal depth is from the first camera and the second file based upon the image, video, or hologram with a low focal depth is from the second camera. Using the present imaging system, one may readily adjust the ARP without adversely affecting the LRP associated with the image.

The embodiment disclosed with reference to the second embodiment shown in FIG. 2 uses two image sensing devices with one recording the scene with a high focal depth and another recording it with a low focal depth. Alternatively, the imaging can also be performed using a single polarization sensitive (4-pol) camera and the above-mentioned recording of scene with high and low focal depths are polarized along orthogonal directions. In this case, a single polarization sensitive imaging device can record all the required images, videos, and holograms with a single camera shot.

The second embodiment, INCHIS-H2, is implemented using both active as well as passive optical elements with lens and axicon functions. In accordance with the second embodiment, INCHIS-H2, ARP is changed digitally after optical recording. In the second embodiment, INCHIS-H2, two camera shots of the same scene are recorded, one with a refractive axicon 112 and another with a refractive lens 114 and the ARP is engineered post recording by controlling the strengths of the two intensity distributions. Once again, the tunability range is within the axial resolution limits of the refractive axicon 112 and the refractive lens 114.

The imaging systems disclosed herein achieve ARP without adversely affecting the lateral resolving power may take two different forms. That is, imaging system may take the form of one of two disclosed INCoherent Hybrid Imaging Systems (INCHIS) for tuning ARP independent of LRP. Each of these INCoherent Hybrid Imaging Systems uses deterministic optical fields and LR²A wherein T₁ and T₂ are used to change the ARP between the limits of Bessel beams and spherical beams independent of LRP. While it is understood that spatially incoherent and temporally coherent light source is preferred for most imaging applications due to a higher resolution and lower imaging noises: speckle noise and edge ringing effects, in comparison to spatially and temporally coherent light sources, the present imaging system that only uses spatially incoherent light sources are considered.

As will be appreciated based upon the following disclosure, INCHIS-H1 requires pre-engineering of phase masks, while INCHIS-H2 requires only post-engineering of holograms. In accordance with both INCHIS-H1 and INCHIS-H2, a method and system are provided to engineer the AR of recorded images, videos, and holograms allowing one to focus and defocus different planes relative to one another. It is possible to change ARP, without changing LRP, allowing one to simultaneously digitally refocus multiple planes and refocus one plane with respect to another.

While it is known that there are other methods developed by Rai and Rosen [M. R. Rai and J. Rosen, “Depth-of-field engineering in coded aperture imaging,” Opt. Express 29, 1634-1648 (2021)] and A. Bleahu, et. al. [A. Bleahu, et. al. “3D incoherent imaging using an ensemble of sparse self-rotating beams,” Opt. Express 31, 26120-26134 (2023)] for real time tuning of ARP and for separating objects with same lateral locations, and that these methods can be efficiently adapted for tuning ARP after completing the recording process, the post tuning processes are complicated and cannot be implemented using refractive elements.

INCHIS-H1 is simpler than the above methods for realtime tuning of ARP. INCHIS-H2 address the deficiencies of the above methods in tuning ARP post recording. As will be appreciated based upon the following detailed disclosure, INCHIS-H1 does require pre-engineering of phase masks to change ARP, like any conventional imaging system. However, INCHIS-H2 does not require pre-engineering. INCHIS-H1 and INCHIS-H2 provide for the ability to change ARP real-time and post-recording respectively and open new pathways in imaging technology. In addition to disclosing the INCHIS-H1 and INCHIS-H2, the following disclosure presents simulation results and proof-of-concept experimental results. As discussed below in great detail, the recently developed LR²A is used for image reconstruction for the above cases. It is believed that the developed INCHIS-H1 and INCHIS-H2 methodologies will revolutionize the field of incoherent digital holography (IDH), computational imaging, computer vision, and microscopy.

### 2. Methodology

The optical configurations of INCHIS-H1 and INCHIS-H2 are shown in FIGS. 1 and 2, respectively.

### 2.1 INCHIS-H1

In INCHIS-H1, the pure phase masks (that is, the diffractive axicon 12, the diffractive lens 14) and the degrees of freedom (DoF) 24 for hybridization are selected in the first step and the corresponding hybrid phase masks are calculated. A. Vijayakumar and S. Bhattacharya, Design and Fabrication of Diffractive Optical Elements with MATLAB (SPIE, 2017). In accordance with a disclosed embodiment, the phase-only masks for generating pure optical fields are multiplexed into a phase mask 70 (which may be pure or hybrid as discussed above) using the recently developed computational algorithm, transport of amplitude into phase based on Gerchberg-Saxton algorithm (TAP-GSA) 16. R. W. Gerchberg, and W. O. Saxton, “A practical algorithm for the determination of phase from image and diffraction plane pictures,” Optik 35, 227-246 (1972); S. Gopinath, et. al. “Enhanced design of multiplexed coded masks for Fresnel incoherent correlation holography,” Sci. Rep. 13, 7390 (2023), which is incorporated herein by reference. Multiplexing the phase masks using (TAP-GSA) 16 into a phase mask 70 is a necessary step as simply combining two pure phase functions results in a complex function which is difficult to implement in experiments. If random multiplexing was used to combine two pure phase functions, it leads to scattering noises. S. Gopinath, et. al. “Enhanced design of multiplexed coded masks for Fresnel incoherent correlation holography,” Sci. Rep. 13, 7390 (2023). While it is possible to multiplex several phase masks using TAP-GSA, the disclosed method only utilizes two phase masks that are ultimately multiplexed using (TAP-GSA) 16 into the phase mask 70. The strengths of the two masks are controlled by two variables namely T₁ and T₂, representing the strengths of the phase modulators, namely lens and axicon, respectively. The resulting phase-only mask 70 from TAP-GSA 16 is displayed on a spatial light modulator (SLM) and the point spread function (l_{PSF}) library is recorded at different depths using a point object. Then an object 34 is recorded with the same pure phase mask 70 (that is, either axicon or lens with T₁=1 and T₂=0 (for lens) and T₁=0 and T₂=1 (for axicon) as shown in FIG. 1) and exactly the same experimental conditions. The 3D image of the object 34 can be reconstructed by processing the l_{PSF} library and object intensity distribution using one of the reconstruction methods such as matched filter, phase-only filter, NLR and LR²A. J. L. Horner and P. D. Gianino, “Phase-only matched filtering,” Appl. Opt. 23 (6), 812-816 (1984); V. Anand, M. Han, J. Maksimovic, S. H. Ng, T. Katkus, A. Klein, K. Bambery, M. J. Tobin, J. Vongsvivut and S. Juodkazis, “Single-shot mid-infrared incoherent holography using Lucy-Richardson-Rosen algorithm,” Opto-Electron. Sci. 1, 210006 (2022). Depending upon T₁ and T₂, the ARP of the imaging system varies. When the phase mask 70 is pure, i.e., either axicon or lens, then the system behaves similar to I-COACH and coded aperture imaging (CAI) as only a single beam is generated (see Lens T₁=1 and T₂=0 and Axicon T₁=0 and T₂=1 in FIG. 1). When a hybrid phase mask 70 (i.e., a combination of axicon and lens as shown in FIG. 1) is used, multiple beams are generated and self-interfered and the imaging system behaves similar to FINCH or COACH.

More specifically, and in accordance with a disclosed embodiment, a point object 10 located at (r̅ₛ, zₛ) and emitting light with an amplitude of Iₛ is considered. A hybrid phase mask 70 designed by combining the phase masks of a diffractive axicon 12 and a diffractive lens 14 using TAP-GSA 16 is located at a distance of zₛ from the point object 10. The complex amplitude of the hybrid phase mask 70 is given as ψ_{M}≈exp[−iπT₁(λf)⁻¹(x²+y²)]+exp[−i2πT₂∧⁻¹\sqrt{x²+y²}], where f is the focal length of the diffractive lens, ∧ is the period of the diffractive axicon, λ is the wavelength, 0≤T₁≤1 and 0≤T₂≤1 and ψ_{M} is a phase-only function. For simplicity, only a single wavelength λ is considered. The variables T₁ and T₂ control the contributions from the diffractive lens 14 and the diffractive axicon 12, respectively. When T₁=0 and T₂=1, the hybrid phase mask 70 reduces to a diffractive axicon 12 and when and T₁=1 and T₂=0, the hybrid phase mask 70 reduces to a diffractive lens 14 and for other values of T₁ and T₂, a hybrid phase mask 70 is obtained.

TAP-GSA 16 has been thoroughly investigated. S. Gopinath, et. al. “Enhanced design of multiplexed coded masks for Fresnel incoherent correlation holography,” Sci. Rep. 13, 7390 (2023). In accordance with a disclosed embodiment as shown in FIG. 1, the TAP-GSA 16 algorithm is processed in the following manner. Fresnel propagators 28a, 28b are used to connect the two planes of interest namely a mask plane 20 and a sensor plane 22. It should be appreciated that the two Fresnel propagators 28a, 28b are similar but are used for different purposes in the system and are shown in two places in the diagram of FIG. 1. In the first step, two or more pure phase functions 50, 52 are summed, resulting in a complex function 53. This complex function 53 is the ideal function in the mask plane 20. In the shown case, two pure phase functions named ‘pure phase 1’ 50 and ‘pure phase 2’ 52 are used. The resulting complex function 53 is numerically propagated from the mask plane 20 using a Fresnel propagator 28a to a distance, as required in an optical experiment, to the sensor plane 22, and the resulting magnitude 54 of the complex amplitude is the ideal function at the sensor plane 22. As discussed below, the resulting magnitude 54 of the complex amplitude obtained by Fresnel propagation 28a of the ideal complex function to the sensor plane 22 is used as a constraint in the sensor plane 22. Similarly, the resulting phase of the complex amplitude 60 is the ideal phase at the sensor plane 22.

The TAP-GSA 16 begins with the mask plane 20 with the phase of the ψ_{M}, that is, a phase 58 extracted from the phase of the ideal complex function 53 as discussed above with regard to the initial step of the process. The TAP-GSA 16 beginning with the mask plane 20 with the phase of the v is then propagated to the sensor plane 22 by the Fresnel propagator 28b. At the sensor plane 22, the amplitude information 62 resulting from the propagation of the mask plane 20 to the sensor plane 22 is replaced completely by the constraint which is the amplitude information obtained if ψ_{M} is propagated to the sensor plane 22 by the Fresnel propagator 28a, that is, the resulting magnitude 54 of the complex amplitude as discussed above with regard to the initial step of the process. The phase information 32 is partially replaced by the phase information 60 obtained at the sensor plane 22 if ψ_{M} is propagated by Fresnel propagator 28a, that is, the resulting phase of the complex amplitude 60 as discussed above with regard to the initial step of the process. The phase information 33 resulting from the partial replacement of the phase information 32 along with the ideal magnitude is subsequently back propagated to the mask plane 20 by an inverse Fresnel propagator 30. The degrees of freedom (DoF) 24 is the ratio between the number of pixels replaced in the phase matrix of the sensor 26 by total number of pixels of the matrix. The resulting magnitude 54 of the complex amplitude is back propagated to the mask plane 20 by an inverse Fresnel propagator 30. The magnitude 54 of the resulting complex amplitude is replaced by a uniform matrix 56 and the phase 65 is carried on; that is, the uniform matrix 56 and the phase 65 are once again propagated from the mask plane 20 to the sensor plane 22 via the Fresnel propagator 28. After several iterations, the TAP-GSA 16 converges and yields a phase-only function 32 that can generate the optical fields corresponding to the two-parent pure-phase functions 50, 52 with minimal scattering noise; that is, when the resulting phase-only function reaches a desired root-mean-square error value.

The complex amplitude after the hybrid phase mask 70 is given as

$$\sqrt{{I}_{s}} {C}_{1} L ( \frac{{\overline{r}}_{s}}{{z}_{s}} ) Q ( \frac{1}{{z}_{s}} ) {ψ}_{M} ,$$

where L and Q are the linear and quadratic phase functions given as

$$L ( \frac{\overline{s}}{z} ) = exp [ i 2 {π ( λ z )}^{- 1} ( {s}_{x} x + {s}_{y} y ) ] and Q ( b ) = exp [ i π b {λ}^{- 1} ( {x}^{2} + {y}^{2} ) ] ,$$

respectively, and C₁ is a complex constant. A self-interference is obtained between the Bessel beam and the spherical beam as both are derived from the same object point. The l_{PSF} recorded by the image sensor located at a distance of zₕ is given as

$${I}_{PSF} ( {\overline{r}}_{0} ; {\overline{r}}_{s} , {z}_{s} ) = {\vert \sqrt{{I}_{s}} {C}_{1} L ( \frac{{\overline{r}}_{s}}{{z}_{s}} ) Q ( \frac{1}{{z}_{s}} ) {ψ}_{M} ⊗ Q ( \frac{1}{{z}_{h}} ) \vert}^{2} , \qquad ( 1 )$$

where, ‘\textcircled{X}’ is a 2D convolutional operator and r̅₀=(u, v) is the location vector in the sensor plane. Now substituting for ψ_{M} in equation (1), we obtain

$${I}_{PSF} ( {\overline{r}}_{0} ; {\overline{r}}_{s} , {z}_{s} ) = {\vert \sqrt{{I}_{s}} {C}_{1} L ( \frac{{\overline{r}}_{s}}{{z}_{s}} ) Q ( \frac{1}{{z}_{s}} ) \{ exp [ - i π {{T}_{1} ( λ f )}^{- 1} ( {x}^{2} + {y}^{2} ) ] + exp [ - i 2 π {T}_{2} {Λ}^{- 1} \sqrt{{x}^{2} + {y}^{2}} ] \} ⊗ Q ( \frac{1}{{z}_{h}} ) \vert}^{2} . \qquad ( 2 )$$

After grouping the individual contributions, we get

$${I}_{P S F} ( {\overline{r}}_{0} ; {\overline{r}}_{s} , {z}_{s} ) = {\vert \sqrt{{I}_{s}} {C}_{1} L ( \frac{{\overline{r}}_{s}}{{z}_{s}} ) Q ( \frac{1}{{z}_{s}} ) exp [ - i π {{T}_{1} ( λ f )}^{- 1} ( {x}^{2} + {y}^{2} ) ] ⊗ Q ( \frac{1}{{z}_{h}} ) + \sqrt{{I}_{s}} {C}_{1} L ( \frac{{\overline{r}}_{s}}{{z}_{s}} ) Q ( \frac{1}{{z}_{s}} ) exp [ - i 2 π {T}_{2} {Λ}^{- 1} \sqrt{{x}^{2} + {y}^{2}} ] ⊗ Q ( \frac{1}{{z}_{h}} ) \vert}^{2} , \qquad ( 3 )$$

$${I}_{PSF} ( {\overline{r}}_{0} ; {\overline{r}}_{s} , {z}_{s} ) = {\vert {A}_{DL} + {A}_{DA} \vert}^{2} , \qquad ( 4 )$$

where A_{DL} and A_{DA} are the complex amplitudes with diffraction efficiencies corresponding to maximum phases (2πT₁) and (2πT₂) generated for the diffractive lens 14 and diffractive axicon 12 respectively and are a spherical beam given as

$$Q ( \frac{1}{{z}_{e}} ) , where \frac{1}{{z}_{e}} = \frac{1}{{z}_{s}} + \frac{1}{{z}_{h}} - \frac{1}{f}$$

and a Bessel beam of first kind J₀. The transverse magnification of the system is given as M_{T}=zₕ/zₛ. The l_{PSF} can be expressed as

$${I}_{PSF} ( {\overline{r}}_{0} ; {\overline{r}}_{s} , {z}_{s} ) = {I}_{PSF} ( {\overline{r}}_{0} - \frac{{z}_{h}}{{z}_{s}} {\overline{r}}_{s} ; 0 , {z}_{s} ) . \qquad ( 5 )$$

A 2D object consisting of M points can be represented as a collection of M Kronecker Delta functions as

$$o ( {\overline{r}}_{s} ) = {\sum }_{j}^{M} {a}_{j} δ ( \overline{r} - {\overline{r}}_{s , j} ) , \qquad ( 6 )$$

where aⱼ′s are constants. Since only spatially incoherent illumination is considered in accordance with a disclosed embodiment, the light diffracted from one point do not interfere with light diffracted from another, but their intensities add up in the sensor plane. Therefore, the object intensity distribution obtained for o can be expressed as

$${I}_{O} ( {\overline{r}}_{0} ; {z}_{s} ) = {\sum }_{j}^{M} {a}_{j} {I}_{PSF} ( {\overline{r}}_{0} - \frac{{z}_{h}}{{z}_{s}} {\overline{r}}_{s , j} ; 0 , {z}_{s} ) . \qquad ( 7 )$$

The goal is to reconstruct the object o from l_{PSF} and l_{O} given by Eq. (5) and Eq. (7) respectively. If the autocorrelation of l_{PSF} gives a Delta-like function, then the object o can be reconstructed by a cross-correlation between l_{PSF} and l_{O}. In a recent study, the use of NLR generated a sharp autocorrelation function and therefore reconstructed intensity distributions of multipoint objects effectively. D. Smith, et. al. “Nonlinear reconstruction of images from patterns generated by deterministic or random optical masks—concepts and review of research,” J. Imaging 8, 174 (2022). The reconstructed image by matched filter is given as

$$\begin{matrix}P ( {\overline{r}}_{R} ) = \int \int {I}_{O} ( {\overline{r}}_{0} ; {z}_{s} ) {I}_{PSF}^{*} ( {\overline{r}}_{0} - {\overline{r}}_{R} ; {z}_{s} ) d {\overline{r}}_{0} . \\ = \int \int {\sum }_{j} {a}_{j} {I}_{PSF} ( {\overline{r}}_{0} - \frac{{z}_{h}}{{z}_{s}} {\overline{r}}_{s , j} ; {z}_{s} ) {I}_{PSF}^{*} ( {\overline{r}}_{0} - {\overline{r}}_{R} ; {z}_{s} ) d {\overline{r}}_{0} \\ = {\sum }_{j} {a}_{j} γ ( {\overline{r}}_{R} - \frac{{z}_{h}}{{z}_{s}} {\overline{r}}_{s , j} ) \approx o ( \frac{{\overline{r}}_{s}}{{M}_{T}} ) ,\end{matrix} \qquad ( 8 )$$

where ‘*’ means complex conjugate. For a speckle pattern, γ is a Delta-like function. But for most deterministic fields such as Gaussian, Bessel, Laguerre-Gaussian beams, etc., γ is not a Delta-like function. The reconstruction by NLR generates a Delta-like function for both random as well as deterministic optical fields. The reconstruction by NLR is given as

$${I}_{R} = \vert {- 1}^{} \{ {\vert {\tilde{I}}_{PSF} \vert}^{α} exp [ j \cdot arg ( {\tilde{I}}_{PSF} ) ] {\vert {\tilde{I}}_{O} \vert}^{β} exp [ - j \cdot arg ( {\tilde{I}}_{O} ) ] \} \vert , \qquad ( 9 )$$

where α and β are tuned between −1 and 1 until the lowest reconstruction noise quantified by the entropy is obtained, Ĩ is the Fourier transform of l and arg(⋅) is the phase. In recent studies, an algorithm LR²A developed by combining the LRA with NLR yielded a better signal to noise ratio (SNR) than NLR. V. Anand, M. Han, J. Maksimovic, S. H. Ng, T. Katkus, A. Klein, K. Bambery, M. J. Tobin, J. Vongsvivut and

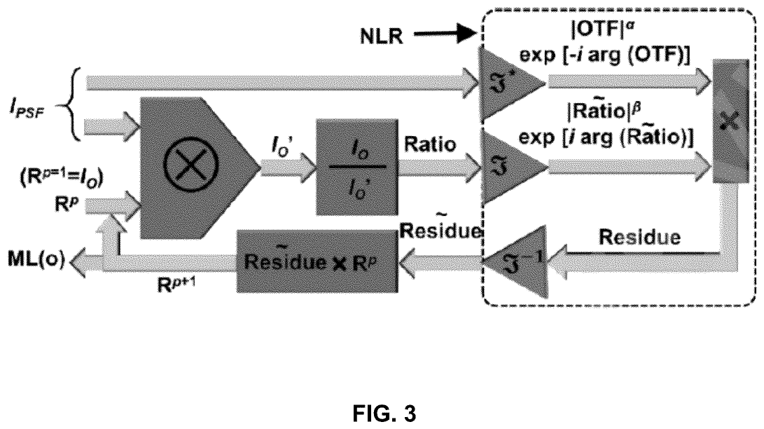

S. Juodkazis, “Single-shot mid-infrared incoherent holography using Lucy-Richardson-Rosen algorithm,” Opto-Electron. Sci. 1, 210006 (2022); P. A. Praveen, et. al. “Deep deconvolution of object information modulated by a refractive lens using Lucy-Richardson-Rosen algorithm,” Photonics, 9, 625 (2022); S. Gopinath, et. al. “Implementation of a large-area diffractive lens using multiple sub-aperture diffractive lenses and computational reconstruction,” Photonics 10, 3 (2023); A. Jayavel, et. al. “Improved classification of blurred images with deep-learning networks using Lucy-Richardson-Rosen algorithm,” Photonics 10, 396 (2023), all of which are incorporated herein by reference. The schematic of LR²A is shown in FIG. 3. The algorithm uses a maximum likelihood solution estimation by iteration of the existing relationship between the object o, l_{PSF} and l_{O}. The algorithm begins with an initial guessed solution of o which is usually l_{O} (R^{p=1}) and is convolved with l_{PSF} and the resulting matrix is compared with l_{O} by calculating the ratio. This ratio is correlated with the l_{PSF} to obtain the residue and multiplied to the previous solution which is R^{p=1}. The process is repeated until the solution converges to a non-changing value. The LRA uses matched filter for performing the correlation which is replaced by NLR to obtain LR²A.

Within the focal depth of the Bessel beam, the A_{DA} remains a constant, while A_{DL} varies. By controlling T₁ and T₂, l_{PSF} can be shifted towards the behaviors of A_{DA} and A_{DL}. When the system is shifted towards A_{DL}, l_{PSF} changes with zₛ and so it is necessary to record l_{PSF} for all values of zₛ. On the other hand, when the system is shifted towards A_{DA}, l_{PSF} does not change with zₛ and so l_{PSF} recorded for one zₛ can be used to reconstruct all if not most of the object planes. Unlike the case with A_{DL}, with A_{DA}, the object information is not blurred or unrecognizable but has a low resolution due to suppression of some higher spatial frequencies. D. Smith, S. H. Ng, M. Han, T. Katkus, V. Anand, K. Glazebrook and S. Juodkazis, “Imaging with diffractive axicons rapidly milled on sapphire by femtosecond laser ablation,” Appl. Phys. B. 127, 154 (2021); D. Smith, et. al. “Nonlinear reconstruction of images from patterns generated by deterministic or random optical masks—concepts and review of research,” J. Imaging 8, 174 (2022).

### 2.2 INCHIS-H2

Generally, and as will be disclosed in greater detail below, in INCHIS-H2, the light from an object point 110 is split into two using a 50-50 beam splitter 111. The two identical object intensity distributions from the beam splitter 111 is modulated by two active or passive optical elements: a refractive lens 114 and a refractive axicon 112 and the two point spread functions l_{PSF-L} and l_{PSF-A} are recorded under identical conditions. An object is recorded in a similar fashion. The point spread function and object intensity distributions are calculated by summing the contributions from refractive lens 114 and refractive axicon 112 after selecting the strengths T₁ and T₂ respectively. The image of the object is then reconstructed by processing the l_{PSF} and object intensity distribution (lₒ) using LR²A. V. Anand, M. Han, J. Maksimovic, S. H. Ng, T. Katkus, A. Klein, K. Bambery, M. J. Tobin, J. Vongsvivut and S. Juodkazis, “Single-shot mid-infrared incoherent holography using Lucy-Richardson-Rosen algorithm,” Opto-Electron. Sci. 1, 210006 (2022). After recording a scene in this fashion using the refractive axicon 112 and refractive lens 114 simultaneously using two cameras 115, 117 under identical conditions, it is possible to engineer the ARP even after recording.

In accordance with a disclosed embodiment shown in FIG. 2, a point object 110 located at (r̅ₛ, zₛ) is considered. It emits light with an amplitude of \sqrt{Iₛ}. The light from the point object 110 is split into two using a 50-50 beam splitter 111. One of the two parts resulting from the beam splitter was modulated by the refractive lens 114 and another by the refractive axicon 112 both located at a distance of zₛ from the point object. Two identical image sensors 115, 117 are mounted at a distance of zₕ from the refractive lens 114 and the refractive axicon 112 respectively such that their optical axes are overlapped. The complex amplitude after the refractive lens 114 and the refractive axicon 112 are given as

$$\sqrt{{I}_{s} / 2} {C}_{1} L ( \frac{{\overline{r}}_{s}}{{z}_{s}} ) Q ( \frac{1}{{z}_{s}} ) exp [ - i π {( λ f )}^{- 1} ( {x}^{2} + {y}^{2} ) ] and$$

$$\sqrt{{I}_{s} / 2} {C}_{1} L ( \frac{{\overline{r}}_{s}}{{z}_{s}} ) Q ( \frac{1}{{z}_{s}} ) exp [ - i 2 π {Λ}^{- 1} \sqrt{{x}^{2} + {y}^{2}} ] respectively .$$

The intensity distributions recorded for a point for a lens (I_{PSF-L}) and an axicon (I_{PSF-A}) are given as

$${I}_{PSF - L} ( {\overline{r}}_{0} ; {\overline{r}}_{s} , {z}_{s} ) = {\vert \sqrt{{I}_{s} / 2} {C}_{1} L ( \frac{{\overline{r}}_{s}}{{z}_{s}} ) Q ( \frac{1}{{z}_{s}} ) exp [ - i π {( λ f )}^{- 1} ( {x}^{2} + {y}^{2} ) ] ⊗ Q ( \frac{1}{{z}_{h}} ) \vert}^{2} , \qquad ( 10 )$$

$${I}_{PSF - A} ( {\overline{r}}_{0} ; {\overline{r}}_{s} , {z}_{s} ) = {\vert \sqrt{{I}_{s} / 2} {C}_{1} L ( \frac{{\overline{r}}_{s}}{{z}_{s}} ) Q ( \frac{1}{{z}_{s}} ) exp [ - i 2 π {Λ}^{- 1} \sqrt{{x}^{2} + {y}^{2}} ⊗ Q ( \frac{1}{{z}_{h}} ) \vert}^{2} . \qquad ( 11 )$$

The point spread function of the system is given as

$${I}_{PSF} ( {\overline{r}}_{0} ; {\overline{r}}_{s} , {z}_{s} ) = {T}_{1} \times {I}_{PSF - L} ( {\overline{r}}_{0} ; {\overline{r}}_{s} , {z}_{s} ) + {T}_{2} \times {I}_{PSF - A} ( {\overline{r}}_{0} ; {\overline{r}}_{s} , {z}_{s} ) , \qquad ( 12 )$$

where 0≤T₁≤1 and 0≤T₂≤1 control the contributions of lens and axicon, respectively. The object intensity distribution can be given by Eq. (7) which is simply I_{O-L}=I_{PSF-L}\textcircled{X}0 and I_{O-A}=I_{PSF-A}\textcircled{X}0 for lens and axicon, respectively. It is possible to reconstruct o by correlating I_{O-A} and I_{PSF-A} respectively or by correlating I_{O-L} and I_{PSF-L} as shown in Eq. (8). The advantage in the proposed method is that the ARP can be tuned after completing the recording process by tuning T₁ and T₂. It is possible to reconstruct o by processing I_{O-L}×T₁+I_{O-A}×T₂ and I_{PSF-L}×T₁+I_{PSF-A}×T₂, as (I_{PSF-L}×T₁+I_{PSF-A}×T₂)\textcircled{X}o=I_{O-L}×T₁+I_{O-A}×T₂.

### 3. Simulation Results

As the following disclosure makes clear, two series of results are presented. The first series of results deals with real time tuning of ARP and the second series of results deals with tuning of ARP post recording. In both cases, when the ARP is tuned, it was noted that the spectral resolution also changes. Therefore, the same approach of tuning the compositions of lens and axicon in the pure phase function, can be used to control the spectral resolution of the system both real-time and post recording using INCHIS-H1 and INCHIS-H2 respectively. Once again, axicon has a low spectral resolution while a lens has a high spectral resolution. Therefore, by tuning the composition of the hybrid element from axicon to lens the spectral resolution can be increased and vice versa.

### A. First Series of Results

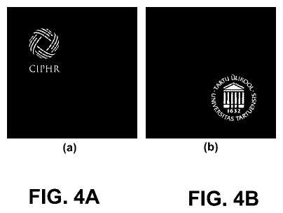

Simulation studies were carried out using MATLAB with a matrix size of 500×500 pixels, pixel size Δ=8 μm, wavelength λ=632.8 nm, and zₕ=30 cm. Two test objects, namely the logos of “CIPHR” and “University of Tartu”. Two object planes corresponding to zₛ=30 cm and 27 cm were considered. A Diffractive Fresnel Zone Plate (DFZP) with a focal length that does not satisfy the imaging condition was designed such that 1/f≠1/zₛ+1/zₕ. A diffractive axicon with a period of 96 μm was designed to generate a Bessel beam. The images of the logos of “CIPHR” and “University of Tartu” are shown in FIGS. 4(a) and 4(b) respectively. The test objects, that is, logos of “CIPHR” and “University of Tartu” are located in plane 1 (zₛ=30 cm) and plane 2 (zₛ=27 cm) respectively. Five cases are considered for simulation: (T₁=1, T₂=0), (T₁=0.75, T₂=0.25), (T₁=0.5, T₂=0.5), (T₁=0.25, T₂=0.75) and (T₁=0, T₂=1) in a fashion of shifting from the characteristics of a lens towards an axicon. The first and fifth cases are pure cases of lens and axicon, respectively. The cases in between lens and axicon constitute hybrid imaging system; that is, those situations where T₁ and T₂ are set between 0 and 1.

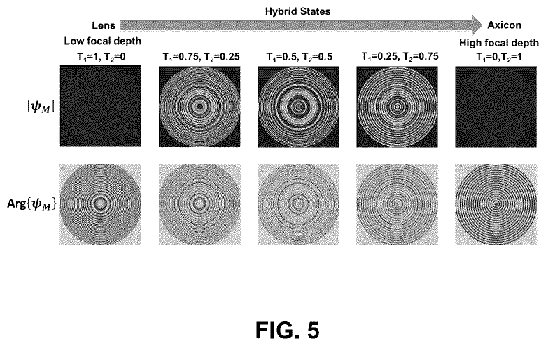

Consider first INCHIS-H1, the amplitude and phase of the diffractive elements for the five cases are shown in FIG. 5. As is seen in FIG. 5, the hybrid cases have both magnitude as well as phase matrices. The axial distributions were calculated for the five cases by processing the l_{PSF}(zₛ=30 cm) with l_{PSF}(20 cm≤zₛ≤30 cm) with a step size of 1 mm using NLR with α=0 and [symbol] =1. In the calculation of axial characteristics, NLR has been used as it is stable and does not require calibration for different sizes of intensity distributions like LR²A.

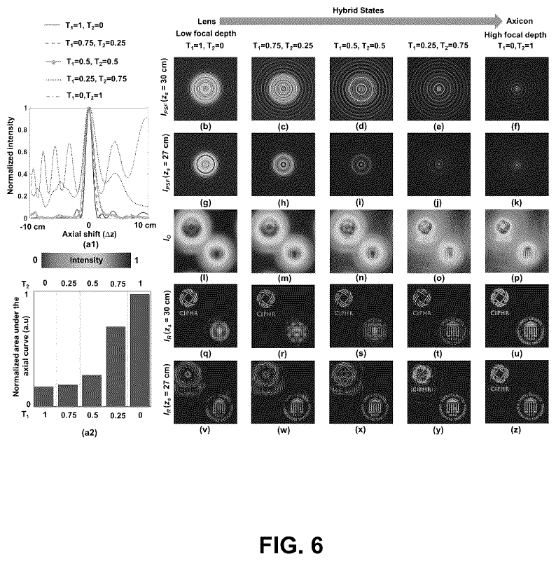

The axial profiles for the five cases are plotted in FIG. 6(a1). As can be seen, there is a non-linear change in ARP when the values of T₁ and T₂ were varied. The axial distribution for the case (T₁=0, T₂=1) resembled the typical axial intensity distribution of an axicon. O. Brzobohatý, T. Čižmár, and P. Zemánek, “High quality quasi-Bessel beam generated by round-tip axicon,” Opt. Express 16, 12688-12700 (2008); C. J. Zapata-Rodríguez and A. Sánchez-Losa, “Three-dimensional field distribution in the focal region of low-Fresnel-number axicons,” J. Opt. Soc. Am. A 23, 3016-3026 (2006). The axial distribution for the case (T₁=1, T₂=0) resembled that of a lens. In between these two cases, mixed axial properties formed by combination of different degrees of lens and axicon are obtained. The area under the axial curve is inversely related to the ARP. The normalized areas under the axial curves for different combinations of T₁ and T₂ are plotted as a bar chart in FIG. 6(a2). The plot of the normalized area under the axial curve quantitively shows the difference in ARP for different combinations of T₁ and T₂ with a maximum ARP for a lens (T₁=1, T₂=0) and minimum ARP for an axicon (T₁=0, T₂=1). The image of the l_{PSF}(zₛ=30 cm), l_{PSF}(zₛ=27 cm), l_{O} and their reconstructions at the two planes l_{R}(zₛ=30 cm) and l_{R}(zₛ=27 cm) using LR²A for (T₁=1, T₂=0), (T₁=0.75, T₂=0.25), (T₁=0.5, T₂=0.5), (T₁=0.25, T₂=0.75) and (T₁=0, T₂=1) are shown in FIGS. 6(b)-6(f), FIGS. 6(g)-6(k), FIGS. 6(l)-6(p), FIGS. 6(q)-6(u) and FIGS. 6(v)-6(z) respectively.

Comparing the reconstruction results for the different cases, it is seen that as the values of T₁ and T₂ were tuned to transform the lens into an axicon through hybrid states, the ARP decreased. Comparing FIGS. 6(q)-6(u), it is seen the “University of Tartu” logo is defocused in the case of 6(q) but the focus improved as the system is shifted towards FIG. 6(u). The same can be observed in FIGS. 6(v)-6(z) where the “CIPHR” logo appears defocused at 6(v) and it gradually improved as the system is shifted towards 6(z). The above effect can also be achieved by increasing the number of beams with different axial characteristics instead of tuning the strength of the two interfering beams. The optimal values of reconstruction using LR²A for the above cases were α=0, 0.5≤β≤0.6 and 4≤p≤10.

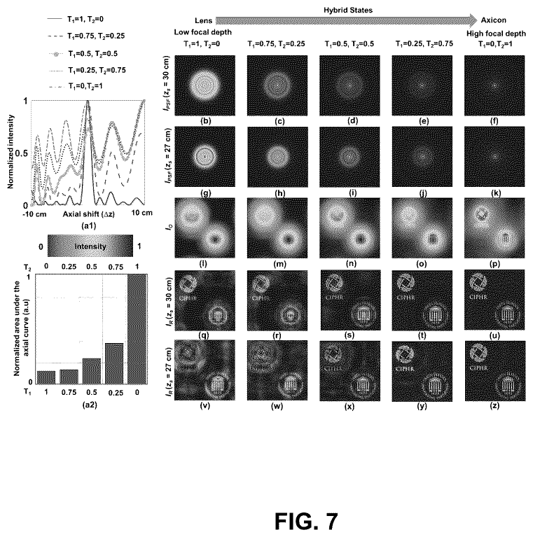

As discussed above, INCHIS-H2 is a post-processing method where two images or two videos, one with a lens and another with an axicon are recorded and combined after applying different weights to the two images or videos using variables T₁ and T₂. When a point spread function with a similar combination from lens and axicon is used to reconstruct images and videos with desirable AR can be obtained. The axial distributions were calculated for the five cases by processing the l_{PSF}(zₛ=30 cm) with l_{PSF}(20 cm≤zₛ≤30 cm) with a step size of 1 mm using NLR with α=0 and [symbol] =1. The plot of the axial curve for (T₁=1, T₂=0), (T₁=0.75, T₂=0.25), (T₁=0.5, T₂=0.5), (T₁=0.25, T₂=0.75) and (T₁=0, T₂=1) are shown in FIG. 7(a1). It can be seen from FIG. 7(a1), the gradual increase of focal depth with increase in T₂ and decrease in T₁ as expected. The normalized areas under the axial curves for different combinations of T₁ and T₂ are plotted as a bar chart in FIG. 7(a2). The plot of the normalized area under the axial curve quantitively shows the difference in ARP for different combinations of T₁ and T₂ with a maximum for a lens (T₁=1, T₂=0) and minimum for an axicon (T₁=0, T₂=1).

The image of the l_{PSF}(zₛ=30 cm), l_{PSF}(zₛ=27cm), l_{O} and their reconstructions at the two planes l_{R}(zₛ=30 cm) and l_{R}(zₛ=27 cm) using LR²A for (T₁=1, T₂=0), (T₁=0.75, T₂=0.25), (T₁=0.5, T₂=0.5), (T₁=0.25, T₂=0.75) and (T₁=0, T₂=1) are shown in FIGS. 7(b)-7(f), FIGS. 7(g)-7(k), FIGS. 7(l)-7(p), FIGS. 7(q)-7(u) and FIGS. 7(v)-7(z) respectively. Comparing the FIGS. 7(b)-7(f), FIGS. 7(g)-7(k) and FIGS. 7(l)-7(p) the transition from the lens to an axicon is evident. Comparing FIGS. 7(q)-7(u) and FIGS. 7(v)-7(z), the object in the plane of the point spread function is reconstructed, while the object in the other plane is not reconstructed well. However, as the system is tuned towards axicon, both objects are reconstructed. The optimal values of reconstruction using LR²A for the above cases were α=0, 0.6≤β≤ 0.7 and 4≤p≤10.

### 4. Experiments

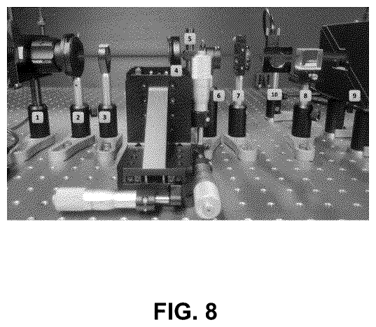

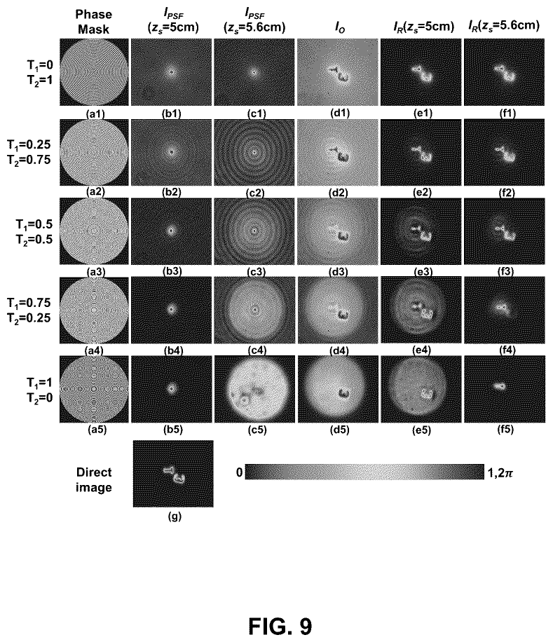

A photograph of the experimental setup is shown in FIG. 8. The set up was built with a high-power LED (Thorlabs, 940 mW, λ=660 nm and Δλ=20 nm), spatial light modulator (SLM) (Thorlabs Exulus HD2, 1920×1200 pixels, pixel size=8 μm) and an image sensor (Zelux CS165MU/M 1.6 MP monochrome CMOS camera, 1440×1080 pixels with pixel size ˜3.5 μm), refractive lens (f=50 mm), United States Air Force (USAF) object or pinhole (that is, a United States Air Force Resolution Target as known in the art), beam splitter, iris and polarizer. The object is critically illuminated using a refractive lens L1. The l_{PSF} was recorded using a pinhole of diameter 10 μm. The objects USAF objects ‘1’ and ‘3’ from Group 5 were used. The light from the object was collimated using a refractive lens L2 and polarized along the active axis of the SLM using a polarizer and passed through the beam splitter to be incident on the SLM normally. Considering the INCHIS-H1 embodiment, the phase masks designed for five combinations (T₁=0, T₂=1), (T₁=0.25, T₂=0.75), (T₁=0.5, T₂=0.5), (T₁=0.75, T₂=0.25), and (T₁=1, T₂=0) moving from axicon to lens are shown in FIGS. 9(a1)-9(a5) respectively. On the SLM, phase masks were displayed one after another and the object intensity distributions are recorded by the image sensor. The phase masks were engineered with a DoF<10%. MATLAB codes for applying TAP-GSA are utilized.

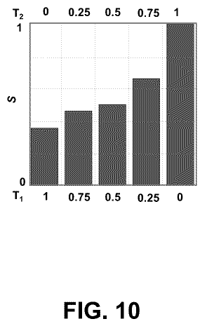

The images of the l_{PSF}s for zₛ=5 cm and 5.6 cm for the five cases are shown in FIGS. 9(b1)-9(b5) and FIGS. 9(c1)-9(c5) respectively. To demonstrate 3D imaging, the l_{O} of object ‘3’ recorded at (zₛ=5 cm) for all the five cases were summed with the corresponding l_{O} of object ‘1’ recorded at (zₛ=5.6 cm) as shown in FIGS. 9(d1) to 9(d5). The reconstruction results l_{R}(zₛ=5 cm) shown in FIGS. 9(e1) to 9(e5) and l_{R}(zₛ=5.6 cm) shown in FIGS. 9(f1) to 9(f5) respectively. The direct image of the object is shown in FIG. 9(g). In 3D imaging, it can be seen that the reconstructed plane appears focused while the other plane is not, and the blur increases as one goes from axicon towards lens. To quantitatively show the variation of ARP for different values of T₁ and T₂, the normalized ratio between the average intensity values at the two planes given as

$$S = \frac{{μ}_{{I}_{R}} ( {O}_{1} )}{{μ}_{{I}_{R}} ( {O}_{2} )} ,$$

where O₁ is the object that is out of focus and O₂ is the object that is in focus during reconstruction, is plotted as shown in FIG. 10.

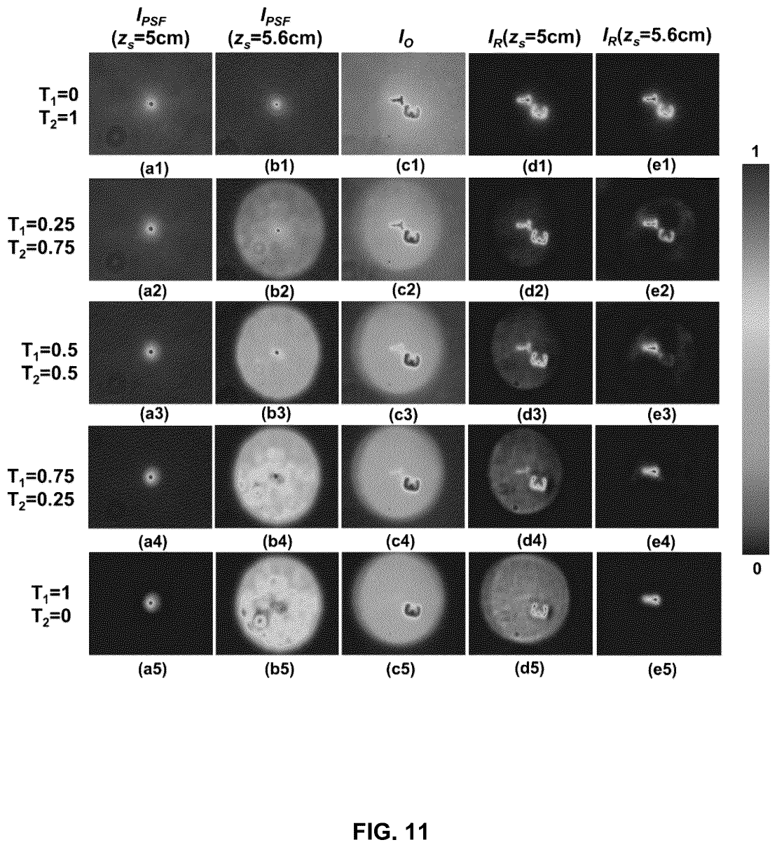

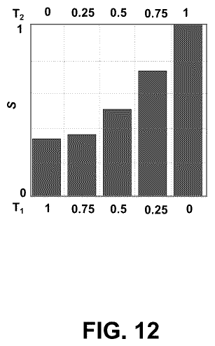

For INCHIS-H2, the recorded images of axicon and lens were combined after applying different weights to the two images using T₁ and T₂. In the first step, the l_{PSF} of a particular plane (zₛ=5 cm) of lens and axicon were taken and the weights T₁=0.25 and T₂=0.75 were applied and summed to obtain the l_{PSF} for the second case (T₁=0.25, T₂=0.75). Similarly, the l_{O} of axicon and lens were taken and the weights T₁=0.25 and T₂=0.75 were applied and summed to obtain the l_{O} for the second case (T₁=0.25, T₂=0.75). This process was repeated by applying different weights to l_{PSF} and l_{O} for the other cases. The 3D imaging results are shown in FIG. 11. The images of the l_{PSF}s for zₛ=5 cm and 5.6 cm for the five cases are shown in FIGS. 11(a1)-11(a5) and FIGS. 11(b1)-11(b5) respectively. A second plane information l_{O} of object ‘3’ recorded at (zₛ=5 cm) for all the five cases was summed with the corresponding l_{O} of object ‘1’ as shown in FIGS. 11(c1) to 11(c5). The reconstruction results l_{R}(zₛ=5 cm) are shown in FIGS. 11(d1) to 11(d5) and the reconstruction results l_{R}(zₛ=5.6 cm) are shown in FIGS. 11(e1) to 11(e5) respectively for the five cases. It can be seen from the above figures that the plane of interest appears focused while the blur of the other plane increases from axicon to lens. In all the above studies LR²A was operated with 0.3≤α≤0.6, β=1 and 25≤p≤35. To quantitatively show the variation of ARP for different values of T₁ and T₂, the normalized ratio between the average intensity values at the two planes given as S is plotted as shown in FIG. 12.

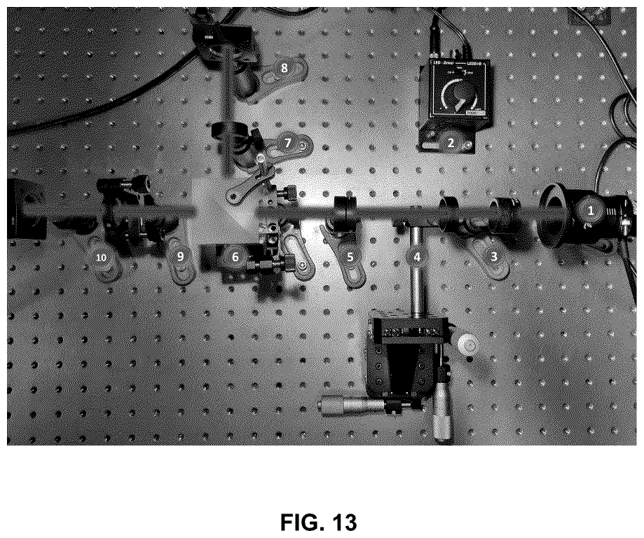

Additional experiments demonstrating INCHIS-H2 were conducted using passive elements, that is, lens and axicon, as shown in FIG. 13.

Referring to FIG. 13, a photograph of the experimental setup is shown with the following elements: (1) LED, (2) LED power controller, (3) refractive lens L1 (f=50 mm), (4) object/pinhole, (5) refractive lens L2 (f=100 mm), (6) beam splitter, (7) refractive lens L3 (f=100 mm), (8) image sensor 1, (9) axicon (10) image sensor 2. The red line shows the path of the beam from LED to image sensor 1 and image sensor 2.

In particular, the set up consists of a high-power LED (Thorlabs, 940 mW, λ=660 nm and Δλ=20 nm), refractive lens (f=50 mm), refractive lens (f=100 mm), pinhole (50 μm), beam splitter, solid axicon and two image sensors (Zelux CS165MU/M 1.6 MP monochrome CMOS camera, 1440×1080 pixels with pixel size ˜3.5 μm). The object was critically illuminated using a refractive lens L1. The light from the object was collimated using a refractive lens L2, and the collimated light entered into the beam splitter. The beam splitter divided the beam into two. The first beam from the beam splitter was incident on a refractive lens L3 and the l_{O} corresponding to the lens was recorded by image sensor 1. The second beam from the beam splitter was incident on the axicon and the l_{O} corresponding to axicon was recorded by image sensor 2. The image sensor 1 and image sensor 2 were located at a distance of 15 cm from the beam splitter and their optical axes overlapped. The l_{PSF} was recorded in the first step using the 50 μm pinhole. The same 50 μm pinhole was shifted from the center to four different positions in vertical and horizontal directions to create a multipoint object. To demonstrate 3D imaging, the l_{PSF} and l_{O} were recorded at two different depths (zₛ=10 cm) and (zₛ=11.7 cm). In the first step, the pinhole is shifted to the first horizontal position at a depth (zₛ=10 cm) and the intensity distribution was recorded for the two channels. In the second step, the pinhole is shifted to the second horizontal position at the same depth and again the intensity distribution was recorded for the two channels. The l_{O} for lens and axicon were obtained by summing the recordings at the respective channels.

Similarly, the process was repeated by moving the pinhole to the first and second vertical positions at a depth (zₛ=11.7 cm) and the l_{O} corresponding to lens and axicon were obtained as described. The recorded l_{O} of two horizontal points at a depth (zₛ=10 cm) and two vertical points at a depth (zₛ=11.7 cm) of lens and axicon are summed together to obtain the l_{O} of 3D multipoint object for lens and axicon. Now the recorded l_{PSF} and l_{O} of lens and axicon are combined after applying different weights to the two images using T₁ and T₂. In the first step, the l_{PSF} of the first plane (zₛ=10 cm) of lens and axicon were taken and the weights T₁=0.25 and T₂=0.75 were applied and summed to obtain the l_{PSF} for the second case (T₁=0.25, T₂=0.75). Similarly, the l_{O} of lens and axicon were taken and the weights T₁=0.25 and T₂=0.75 were applied and summed to obtain the l_{O} for the second case (T₁=0.25, T₂=0.75). This process was repeated by applying different weights to l_{PSF} and l_{O} for the other cases (T₁=0.5, T₂=0.5). (T₁=0.75, T₂=0.25) and (T₁=0.875, T₂=0.125). The optimal values of reconstruction using LR²A for the all the cases were 0.2≤α≤0.5, [symbol] =1, and 3≤p≤10.

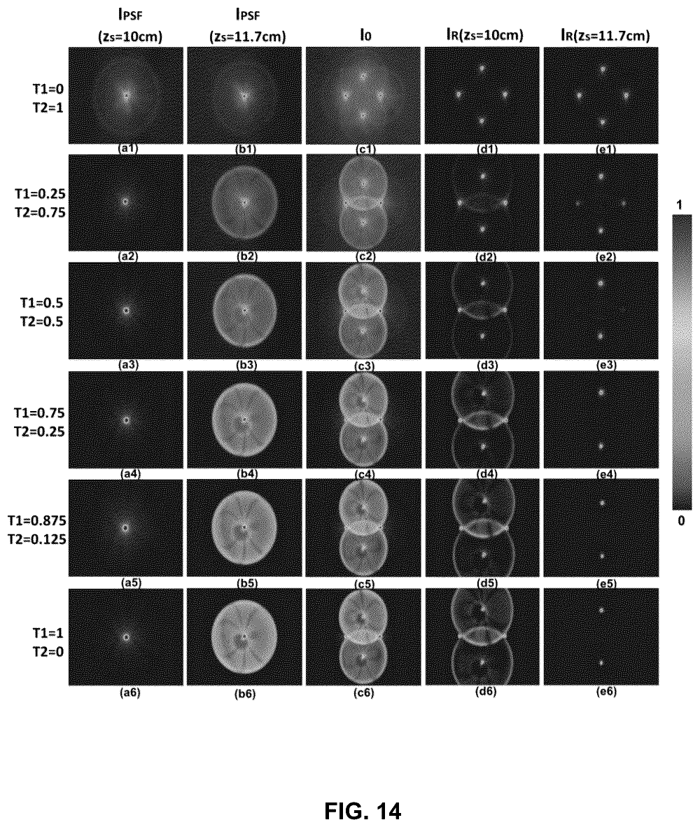

The results are shown in FIG. 14. The l_{PSF} for (zₛ=10 cm) are shown in FIGS. 14(a1) to 14(a6) and (zₛ=11.7 cm) are shown in FIGS. 14(b1) to 14(b6), the l_{O} is shown in FIGS. 14(c1) to 14(c6), the reconstruction results by LR²A for l_{R}(zₛ=10 cm) are shown in FIGS. 14(d1) to 14(d6) and l_{R}(zₛ=11.7 cm) are shown in FIGS. 14(e1) to 14(e6) for the six cases (T₁=0, T₂=1), (T₁=0.25, T₂=0.75), (T₁=0.5, T₂=0.5), (T₁=0.75, T₂=0.25) and (T₁=0.875, T₂=0.125) and (T₁=1, T₂=0) respectively.

From the reconstruction results corresponding to the depth l_{R}(zₛ=10 cm) in FIG. 14, it can be seen that in the case of axicon (T₁=0, T₂=1), the two horizontal points are focused since the plane of interest of two points matches with the plane of l_{PSF} and since the axicon has a very long focal depth, the two vertical points are also focused even though it does not match with the plane of l_{PSF}. In the second case (T₁=0.25, T₂=0.75), the two horizontal points are focused as it matches with plane of l_{PSF} and the two vertical points are blurred. In the third case (T₁=0.5, T₂=0.5), the two horizontal points are focused similarly and the two vertical points are blurred. But, one can notice that the blur of two vertical points is more compared to the second case. Similarly, in the following cases (T₁=0.75, T₂=0.25), (T₁=0.875, T₂=0.125) and (T₁=1, T₂=0), the two vertical points are focused and the two horizontal points are blurred. Now moving on to the reconstruction results corresponding to the depth l_{R}(zₛ=11.7 cm), in FIG. 14 similarly in the case of axicon (T₁=0, T₂=1), all the four points are focused. In the second case (T₁=0.25, T₂=0.75), the two vertical points are focused as it matches with plane of l_{PSF} and the two horizontal points are blurred. Similarly, in the remaining cases (T₁=0.5, T₂=0.5), (T₁=0.75, T₂=0.25), (T₁=0.875, T₂=0.125) and (T₁=1, T₂=0), the two vertical points are focused and the two horizontal points are blurred. From these reconstruction results we observed and conclude that blur increased when we move from axicon (T₁=0, T₂=1) to lens (T₁=1, T₂=0) which clearly indicates the change in ARP i.e., the ARP is low in the case of axicon (T₁=0, T₂=1) and high in the case of lens (T₁=1, T₂=0) and it increases when we move from axicon (T₁=0, T₂=1) to lens (T₁=1, T₂=0).

### 5. Discussion

In this study, two hybridization methods INCHIS-H1 and INCHIS-H2 are disclosed and demonstrated. INCHIS-H1 was inspired from a previous study. A. Vijayakumar, Y. Kashter, R. Kelner, and J. Rosen, “Coded aperture correlation holography (COACH) system with improved performance [Invited],” Appl. Opt. 56, F67-F77 (2017), but is more advanced than that study with respect to all the characteristics of imaging and the implementation. The method proposed in Vijayakumar, Y. Kashter, R. Kelner, and J. Rosen, “Coded aperture correlation holography (COACH) system with improved performance [Invited],” Appl. Opt. 56, F67-F77 (2017), was based on FINCH and COACH and so it was necessary to convert every object point into at least three beams: spherical, plane, and chaotic, and at least three camera shots were required. In INCHIS-H1, every object point is converted into two beams: spherical and Bessel and a single camera shot is sufficient. In a way, INCHIS-H1 can be considered FINCH or IDH where the self-interference happens between a Bessel beam and a spherical beam instead of between two spherical beams. By tuning the ratios T₁ and T₂, INCHIS-H1 can be tuned from I-COACH or CAI with lens as coded aperture to I-COACH or CAI with axicon as coded aperture through FINCH. Further, the SNR in the new method is higher than Vijayakumar, Y. Kashter, R. Kelner, and J. Rosen, “Coded aperture correlation holography (COACH) system with improved performance [Invited],” Appl. Opt. 56, F67-F77 (2017). The above is partially due to the nature of the self-interfering beams, i.e., in INCHIS-H1, intensity distributions have higher energy density due to deterministic optical fields in comparison to a scattered beam in COACH. The second reason for a better SNR in INCHIS-H1 compared to COACH is the lower photon budget requirement due to lesser number of beams in INCHIS-H1 than COACH. Finally, TAP-GSA is used in INCHIS-H1 for multiplexing phase masks instead of random multiplexing. Finally, in Vijayakumar, Y. Kashter, R. Kelner, and J. Rosen, “Coded aperture correlation holography (COACH) system with improved performance [Invited],” Appl. Opt. 56, F67-F77 (2017), when the ARP is tuned, LRP is also changed unlike in INCHIS methods. In all the hybrid cases, the DoF of TAP-GSA was low to avoid any loss of light due to scattering.

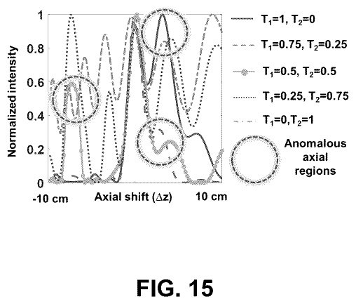

Ideally, as the phase mask is tuned from a lens (T₁=1, T₂=0) to an axicon (T₁=0, T₂=1), the focal depth is expected to improve and on average, this is true. However, there are also anomalous axial regions as seen in FIG. 6(a1) when the axial response does not follow the expected trend locally. In these regions, the reconstruction of images for a phase mask that contains a higher composition of lens than axicon is of better quality than a phase mask with higher composition of axicon than lens with an l_{PSF} that is recorded for a different plane. Such local axial regions are the anomalous axial regions. In binary phase masks, there is an increase in the occurrence of anomalous axial regions due to higher diffraction orders as seen in the supplementary document. The axial profiles for the five cases (T₁=1, T₂=0), (T₁=0.75, T₂=0.25), (T₁=0.5, T₂=0.5), (T₁=0.25, T₂=0.75) and (T₁=0, T₂=1) are plotted for a binary phase mask as shown in FIG. 15. The anomalous axial regions are highlighted with a red dotted circle with yellow glow. In these regions, the variation in AR for different cases do not follow the expected trend. The above problem needs to be addressed in the future studies.

INCHIS-H2 is an elegant and powerful method. The post processing of the recorded intensity distributions involving the addition of the intensity distributions with weights T₁ and T₂, do not create any anomalous axial regions in simulation studies FIG. 7 (a1). In simulation studies, the values of T₁ and T₂ in creating the hybrid l_{PSF} and l_{O} were the same. In experiment, however, it was necessary to change the values of T₁ and T₂ to compensate the changes made to the exposure time and light intensity during recording. This new method allows one to tune the AR of recorded images such as pictures, videos, holograms, etc. As with any new method, the advantage often comes with a penalty and INCHIS-H2 is not an exception. The ability to tune the AR of recorded images such as pictures, videos, and holograms in INCHIS-H2 comes with a penalty which is the need for recording two pictures, two videos, or two holograms instead of one. However, considering the advantages of INCHIS-H2 and considering that most in-line holography methods require at least three camera shots, the penalty is mild.

### 6. Conclusion

Two hybridization methods named INCHIS-H1 and INCHIS-H2 have been developed in the framework of coded aperture imaging (CAI) to tune the ARP independent of LRP. In INCHIS-H1, the well-known FINCH configuration has been adapted where the light from an object point is split into two and modulated by a lens and an axicon and self-interfered. A phase mask is designed by multiplexing the functions of a diffractive lens and a diffractive axicon using TAP-GSA to generate a spherical beam and a Bessel beam which are interfered in the image sensor. The contributions of the diffractive lens and diffractive axicon can be tuned using weights such that the system can be tuned between the imaging characteristics of a diffractive lens and that of a diffractive axicon. The axial characteristics of the hybrid phase masks varied as predicted theoretically but with some local anomalous regions where the properties crossed over between different cases.

The second method INCHIS-H2 involves recording an object with two elements namely lens and an axicon and they are combined with different weights after recording to obtain a desired ARP. The INCHIS-H2 is more attractive than INCHIS-H1 as it allows modifying the AR of recorded pictures and videos, which is significant and is reported for the first time. This new capability to tune ARP will be useful in many applications such as fluorescent microscopy, astronomy, microscopy, computer vision, motion photography and computational imaging.

In both methods, INCHIS-H1 and INCHIS-H2, ARP is changed for a constant LRP defined by ˜λ/NA. The limit of ARP is set at ˜λ/NA² which can be reduced to the ARP of axicon but not improved beyond ˜λ/NA². The LRP can be changed only by conventional means such as changing the NA or changing the size of the pinhole used for recording the l_{PSF}.

Changing LRP of a recorded picture has been reported mostly based on interpolation, extrapolation, deep learning [Y. Zou, L. Zhang, C. Liu, B. Wang, Y. Hu, and Q. Chen, “Super-resolution reconstruction of infrared images based on a convolutional neural network with skip connections,” Opt. Laser Eng. 146, 106717 (2021); Z. Huang and L. Cao, “Bicubic interpolation and extrapolation iteration method for high resolution digital holographic reconstruction,” Opt. Laser Eng. 130, 106090 (2020); B. Wang, Y. Zou, L. Zhang, Y. Li, Q. Chen, and C. Zuo, “Multimodal super-resolution reconstruction of infrared and visible images via deep learning,” Opt. Lasers Eng. 156, 107078 (2022)] and deconvolution methods [A. Jayavel, et. al. “Improved classification of blurred images with deep-learning networks using Lucy-Richardson-Rosen algorithm,” Photonics 10, 396 (2023)]. Modifying the ARP of recorded videos and pictures had been impossible so far. With the development of the INCHIS-H2, it is possible to modify the ARP of recorded pictures and videos. But some recent developments on recording virtual l_{PSF} using wavefront modulation gives hope for a better future for INCHIS and coded aperture imaging (CAI) methods. X. Yu, K. Wang, J. Xiao, X. Li, Y. Sun, and H. Chen, “Recording point spread functions by wavefront modulation for interferenceless coded aperture correlation holography,” Opt. Lett. 47, 409-412 (2022). It is appreciated that further work could be done to improve the optical architecture, phase masks and computational reconstruction methods to fully exploit the potential of the developed new hybridization methods. We believe that the developed technology will add new capabilities to imaging.

While the preferred embodiments have been shown and described, it will be understood that there is no intent to limit the invention by such disclosure, but rather, is intended to cover all modifications and alternate constructions falling within the spirit and scope of the invention.

1. An incoherent hybrid imaging system for changing axial resolving power (ARP) without affecting lateral resolving power (LRP) after recording a picture, video, and/or a hologram, comprising:
a point object located at (r̅ₛ, zₛ) and emitting light with an amplitude of Iₛ;
at least one image sensing device;
processing systems allowing for changes to axial resolving power without affecting LRP after recording a picture, video, and/or a hologram; and
a graphical user interface allowing for adjustment of the axial resolving power.

2. The incoherent hybrid imaging system according to claim 1, wherein the graphical user interface employs a sliding scale for adjusting axial resolving power.

3. The incoherent hybrid imaging system according to claim 2, wherein the sliding scale is used to adjust T₁ and T₂ that define strengths of phase modulators.

4. The incoherent hybrid imaging system according to claim 3, further including a hybrid phase mask designed by combining the phase masks of a diffractive axicon and a diffractive lens using Transport of Amplitude into Phase using Gerchberg-Saxton algorithm (TAP-GSA) is located at a distance of zₛ from the point object;

5. The incoherent hybrid imaging system according to claim 4, wherein a complex amplitude of the hybrid phase mask is given as ψ_{M}≈exp[−iπT₁(λf)⁻¹(x²+y²)]+exp[−i2πT₂∧⁻¹\sqrt{x²+y²}], where f is the focal length of the diffractive lens, ∧ is the period of the diffractive axicon, λ is the wavelength, 0≤T₁≤1 and 0≤T₂≤1 and ψ_{M} is a phase-only function.

6. The incoherent hybrid imaging system according to claim 4, wherein variables T₁ and T₂ control the contributions from the diffractive lens and the diffractive axicon, respectively.

7. The incoherent hybrid imaging system according to claim 3, wherein the phase modulators are a lens phase modulator and an axicon phase modulator.

8. The incoherent hybrid imaging system according to claim 3, wherein light from an object point is split into two using a 50-50 beam splitter.

9. The incoherent hybrid imaging system according to claim 8, wherein the two identical object intensity distributions from the beam splitter is modulated by two active or passive optical elements.

10. The incoherent hybrid imaging system according to claim 8, wherein the two active or passive optical elements comprise a refractive lens and a refractive axicon, and the two point spread functions l_{PSF-L} and l_{PSF-A} are recorded under identical conditions by two identical image sensors are mounted at a distance of zₕ from the refractive lens and the refractive axicon.

11. The incoherent hybrid imaging system according to claim 10, wherein a point spread function and object intensity distributions are calculated by summing the contributions from refractive lens and refractive axicon after selecting the strengths T₁ and T₂ respectively.

12. The incoherent hybrid imaging system according to claim 11, wherein the image of the object is then reconstructed by processing the l_{PSF} and object intensity distribution (l_{O}) using LR²A.

13. The incoherent hybrid imaging system according to claim 1, further including a hybrid phase mask designed by combining the phase masks of a diffractive axicon and a diffractive lens using Transport of Amplitude into Phase using Gerchberg-Saxton algorithm (TAP-GSA) is located at a distance of zₛ from the point object;

14. The incoherent hybrid imaging system according to claim 13, wherein a complex amplitude of the hybrid phase mask is given as χ_{M}≈exp[−iπT₁(λf)⁻¹(x²+y²)]+exp[−i2πT₂∧⁻¹\sqrt{x²+y²}], where f is the focal length of the diffractive lens, ∧ is the period of the diffractive axicon, λ is the wavelength, 0≤T₁≤1 and 0≤T₂≤1 and ψ_{M} is a phase-only function.

15. The incoherent hybrid imaging system according to claim 14, wherein variables T₁ and T₂ control the contributions from the diffractive lens and the diffractive axicon, respectively.

16. The incoherent hybrid imaging system according to claim 1, wherein light from an object point is split into two using a 50-50 beam splitter.

17. The incoherent hybrid imaging system according to claim 16, wherein the two identical object intensity distributions from the beam splitter is modulated by two active or passive optical elements.

18. The incoherent hybrid imaging system according to claim 16, wherein the two active or passive optical elements comprise a refractive lens and a refractive axicon, and the two point spread functions l_{PSF-L} and l_{PSF-A} are recorded under identical conditions by Two identical image sensors are mounted at a distance of zₕ from the refractive lens and the refractive axicon.

19. The incoherent hybrid imaging system according to claim 18, wherein a point spread function and object intensity distributions are calculated by summing the contributions from refractive lens and refractive axicon after selecting the strengths T₁ and T₂ respectively.

20. The incoherent hybrid imaging system according to claim 18, wherein the Image of the object is then reconstructed by processing the l_{PSF} and object intensity distribution (l_{O}) using LR²A.
